(19) United States
(12) Patent Application Publication
(10) Pub. No.: US 2024/0144222 A1
(43) Pub. Date: May 2, 2024

(54) IMAGING-BASED VISION ANALYSIS AND SYSTEMS AND METHODS ASSOCIATED THEREWITH

(71) Applicant: ZEBRA TECHNOLOGIES CORPORATION, Lincolnshire, IL (US)

(72) Inventor: Darran Michael Handshaw, Sound Beach, NY (US)

(21) Appl. No.: 17/976,976

(22) Filed: Oct. 31, 2022

(51) Int. Cl. G06Q 20/20

(52) U.S. Cl. CPC G06Q 20/203

(57) ABSTRACT

Embodiments of the present invention are directed to vision analysis associated with venue POS stations. In an embodiment, the invention is a method for imaging-based vision analysis at a POS station with an ingress and egress regions, and a direction of travel from the ingress region to the egress region. In the embodiment the method includes detecting movement of a user through the POS station in the direction of travel and generating an event identifier responsive to (i) the detecting the movement of the user through the POS station in the direction of travel and (ii) not processing a decode of a barcode associated with an item.

### BACKGROUND

Proper accounting of items leaving a retail venue can be imperative to maintaining proper inventory of items. While this can be done with relative ease when consumers lawfully purchase goods by way of checkout operations whereby products are scanned and accounted for, such accounting becomes difficult when individuals steal from a venue bypassing any means to record the fact that a stolen item has been removed from the inventory. Furthermore, shrink events can have a negative financial impact on a venue. This creates a continued need for further systems and methods directed towards helping identify instances of potential shrink events.

### SUMMARY

In an embodiment, the present invention is a vision system for use at a point-of-sale (POS) station of a venue, the POS station having an ingress region, an egress region, and a direction of travel extending from the ingress region to the egress region, the system comprising: a stationary barcode scanner having associated therewith a first imaging assembly operable to capture first image-data and a second imaging assembly operable to capture second image-data, the barcode scanner being configured to operate between the ingress region and the egress region; at least one processor; and a memory storing computer readable instructions that, when executed by the at least one processor, cause the at least one processor to: decode, via the first image-data, barcodes associated with items presented to the barcode scanner within a product scanning region of the barcode scanner, detect, via the second image-data, movement of users through the POS station in the direction of travel, and generate an event identifier responsive to (i) detecting a movement of a user through the POS station in the direction of travel and (ii) not processing a decode of a barcode associated with an item.

In another embodiment, the present invention is a method for imaging-based vision analysis at a POS station of a venue, the POS station having an ingress region, an egress region, and a direction of travel extending from the ingress region to the egress region, the method comprising: detecting, via vision image-data acquired via a vision imaging assembly, movement of a user through the POS station in the direction of travel; and generating an event identifier responsive to (i) the detecting the movement of the user through the POS station in the direction of travel and (ii) not processing a decode of a barcode associated with an item, wherein the decode of the barcode would be performed by image analysis of barcode image-data acquired via a barcode imaging assembly having a field of view (FOV) extending over a product scanning region of a stationary barcode scanner.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates an exemplary point-of-sale (POS) station as it may appear within an exemplary retail venue.

FIG. 2 illustrates an exemplary block diagram of the POS station of FIG. 1.

FIG. 3 illustrates a flowchart representative of an exemplary method or operating the POS station of FIG. 1

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

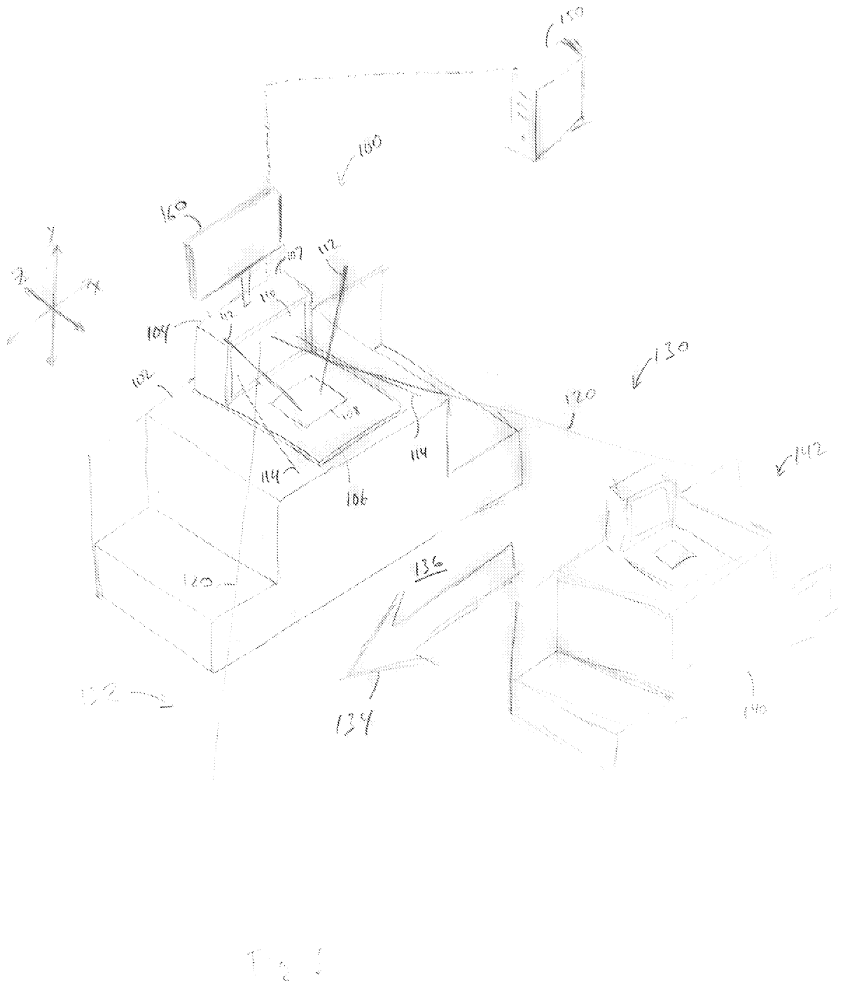

Referring now to FIG. 1, shown therein is an exemplary point-of-sale (POS) station 100 as it may appear within a retail venue such as, for example, a grocery store, a convenience store, etc. The POS station 100 commonly includes a workstation 102 for supporting a barcode reader. In the example shown the barcode reader is illustrated as a bioptic barcode reader 104 having a lower portion 106 that is secured within the workstation 102 and a raised portion 107 extending above the lower portion 106 and above the counter of the workstation 102. The lower portion may include a weigh platter operable to weigh items placed thereon.

The barcode reader of the illustrated embodiment includes two windows for allowing internal imaging components to capture images (also referred to as image data) associated with items presented to the barcode scanner and persons appearing within the region of the POS station. Specifically, the reader 104 includes a generally horizontal window 108 and a generally upright window 110. The generally horizontal window 108 is positioned along a top surface of the lower portion 106 and allows light to be captured over a 2-dimensional field of view (FOV) 112 by an imaging assembly positioned within the barcode reader 104. Similarly, the generally upright window 110 is positioned along a user-facing surface of the raised portion 107 and allows light to be captured over a 2-dimensional FOV 114 by an imaging assembly positioned within the barcode reader 104. It should be appreciated that boundaries of the FOV 112 can be configured in any suitable manner. As such, in some embodiments, the FOV may have an overall diversion angle of less than 70 degrees along the X axis and less than 70 degrees along the Z axis. Additionally, while its central axis extends in a generally vertical direction, it does not have to be normal to the window 108 and may be tilted relative thereto. Furthermore, FOV 112 may be comprised of multiple FOVs combined in some manner to capture image data of objects passing above the lower portion 106.

It should equally be appreciated that boundaries of the FOV 114 can also be configured in any suitable manner. As such, in some embodiments, the FOV may have an overall diversion angle of less than 70 degrees along the X axis and less than 70 degrees along the Y axis. Additionally, while its central axis extends in a generally horizontal direction, it does not have to be normal to the window 110 and may be tilted relative thereto. Furthermore, FOV 114 may be comprised of multiple FOVs combined in some manner to capture image data of objects passing in front of the raised portion 107.

Both FOVs 112 and 114 typically have a limited work range that, in some embodiments, has a maximum of less than 30 inches away from respective window. This distance combined with the boundaries of the FOVs 112 and 114 define a product scanning region of the POS station 100 and more specifically of the barcode reader 104. A product scanning region is a region through with items are normally passed so as to allow the reader 104 to capture one or more images of a barcode affixed to the item and to decode said barcode through image analysis of the captures image(s).

Imaging components used in the barcode reading assembly may include one or more image sensors and respective optics for generating FOVs 112 and 114, and may be viewed as part of a single imaging assembly. Additionally, they may be viewed as part of a single imaging assembly tasked with acquiring image data specifically for purposes of barcode decoding where the image data is generally passed from the image sensor(s) to a decoder module and that decoder module decodes the payload that is encoded in a barcode that is present in an image. Thus, this imaging assembly may be referred to as a barcode imaging assembly. To help increase the speed and efficiency of the system, image sensor(s) used for the barcode imaging assembly is, in some embodiments, a monochrome image sensor.

Further to capturing images for purposes of barcode decoding, the POS station includes imaging components for conducting machine vision operations by way of image analysis of images captured over the 2-dimensional FOV 120. In the illustrated embodiment, the imaging components responsible for generating FOV 120 are positioned within the barcode reader 104 and in a way that causes the FOV 120 to extend through the generally upright window 110 in a generally horizontal manner. As with other FOVs, FOV 120 can be configured in any suitable manner. As such, in some embodiments, the FOV may have an overall diversion angle of greater than 70 degrees along the X axis and greater than 45 degrees along the Y axis. Additionally, while its central axis extends in a generally horizontal direction, it does not have to be normal to the window 110 and may be tilted relative thereto. In some embodiments, the central axis of the FOV 120 may be angled in an upward direction along the Y axis between 0 degree and 45 degrees relative to horizontal (Z axis). Additionally, FOV 120 may be comprised of multiple FOVs combined in some manner to capture relevant image data.

While the imaging components responsible for FOV 120 are illustrated as being positioned within the barcode reader 104, in other embodiments those components may be positioned somewhere within the vicinity of the barcode reader 104 such that the FOV 120 may still be oriented in a way that allows appropriate area coverage to be achieved.

As noted earlier, image data captured over the FOV 120 may be used for conducting machine vision operations which, in some embodiments, include analyzing foot traffic in the region of the POS station 100. Consequently, FOV 120 can be expected to have broader coverage than FOVs 112, 114 and can be expected to extend over at least a portion of region in front of the POS station 100 where a user (e.g., a consumer) may be expected to traverse. Additionally, FOV 120 may overlap with the FOVs 112, 114. With this, FOV 120 may have a working range that is great than FOVs 112, 114, and in some embodiments extends up to, for example, 36 in, 48 in, 60 in, 72 in, 84 in, 120 in.

Imaging components used in the vision imaging assembly may include one or more image sensors and respective optics for generating FOV 120, and may be viewed as part of a single imaging assembly. Additionally, they may be viewed as part of a single imaging assembly tasked with acquiring image data specifically for purposes of machine vision image analysis where the image data is generally passed from the image sensor(s) to an analyzer module and that analyzer module provides analysis results based on image data presented in the image. Thus, this imaging assembly may be referred to as a vision imaging assembly. To help capture the necessary details for vision analysis, the sensor(s) used for the vision imaging assembly is, in some embodiments, a colored image sensor.

Each of the barcode imaging assembly and the vision imaging assembly may use an imaging sensor that is a solid-state device, for example, a CCD or a CMOS imager, having a one-dimensional array of addressable image sensors or pixels arranged in a single row, or a two-dimensional array of addressable image sensors or pixels arranged in mutually orthogonal rows and columns, and operative for detecting return light captured by a lens group over a respective imaging FOV along an imaging axis that is normal to the substantially flat image sensor. The lens group is operative for focusing the return light onto the array of image sensors (also referred to as pixels) to enable the image sensor, and thereby the imaging assembly, to form a digital image. In particular, the light that impinges on the pixels is sensed and the output of those pixels produce image data that is associated with the environment that appears within the FOV. This image data may be processed by an internal controller/processor (e.g., by being sent to a decoder which identifies and decodes decodable indicia captured in the image data) and/or it may be sent upstream to the host 150 for processing thereby.

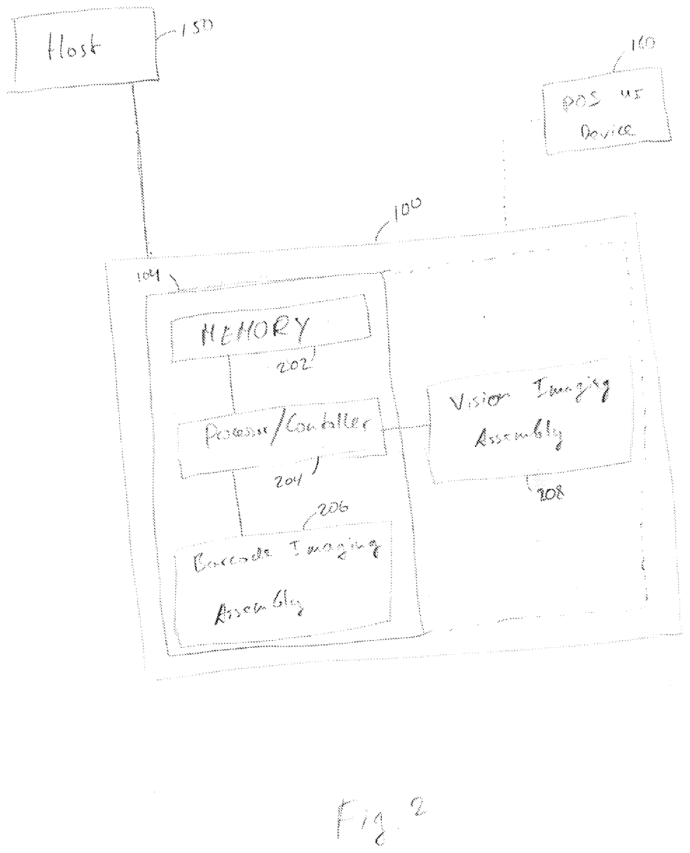

Referring now to FIG. 2, shown therein is an exemplary block diagram of the POS station 100 that is representative of the POS station 100 shown in FIG. 1. Specifically, the POS station 100 includes a barcode reader 104 that includes a memory 202, a processor/controller 204, and a barcode imaging assembly 206. The POS station 100 also includes a vision imaging assembly 208 which, in some embodiments, may be a part of the barcode reader 104.

While each of these elements is referred to as a singular element, it should be understood that each could comprise multiple components and, where possible, may be in a form or a physical or a virtual element. For example, while processor/controller 204 is illustrated as a singular processor, this processor may be comprised or multiple physical and/or virtual processor combined in a way to achieve the required processing and/or control tasks. Additionally, either or any portion of the memory 202 or processor 204 may be located outside the barcode reader 104 such as, for example, on a host 150. In some instances, the host 150 may be a POS device that includes a user interface (UI) that allows a user to process a checkout transaction. In other instances, the POS UI device 160 may be a separate device and the host 150 may be a server that is, for example, operable to perform various processing tasks like image analysis.

In various embodiments, the POS station may be configured to identify potential shrink events by identifying instances of occurring and non-occurring events. This can be achieved by storing various instructions in the memory 202 that, when executed by the processor 204, cause the processor 204 to control imaging assemblies 206 and 208 in certain ways and processor image data in accordance with predefined rules.

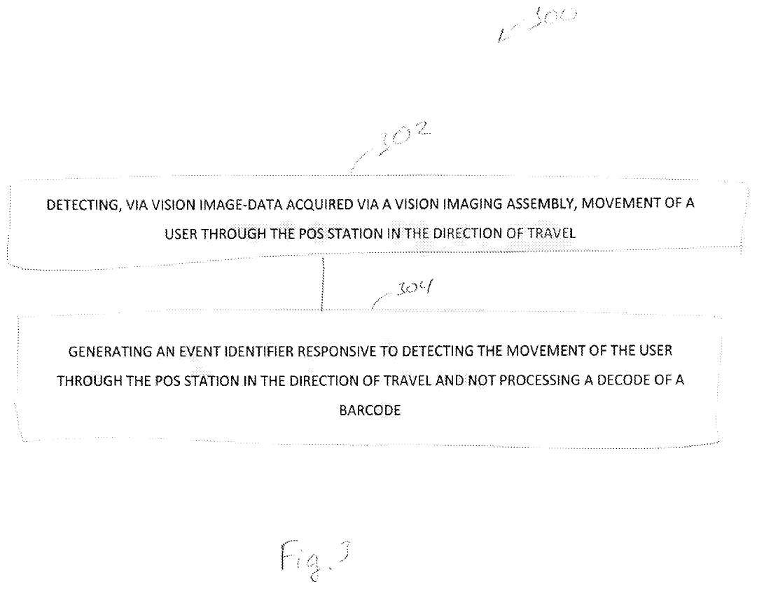

Referring to the flowchart 300 of FIG. 3, in some embodiments, the POS station 100 is configured to detect a potential shrink event in response to identifying movement within the POS station region without a corresponding decode event. For this (referring back to FIG. 1), the POS station 100 is generally configured in a manner where the POS station 100 has an ingress region 130, an egress region 132, and a direction of travel 134. In typical circumstances, the area between the ingress region 130 and the egress region 132 will be a lane 136 that is constrained by the workstation 102 of the subject POS station 100 and a neighboring workstation 140 of a neighboring POS station 142. In this manner, consumers leaving a venue generally pass through the lane 136 in the direction 134.

Under normal circumstances, consumers passing through the POS station 100 generally stop in front of the barcode reader 104 and conduct a transaction operation whereby they pay for goods that they intend to remove from the venue. To help process the transaction, the consumer (also referred to as a user) can use the POS UI device 160 to conduct operations like selecting an appropriate count of items, selecting the correct produce, inputting loyalty card information, and processing the payment component of the transaction. The integral use of the barcode reader during this process is leveraged in the various embodiments of the present invention to identify instances where a perpetrator conducts a shrink event and attempts to or does leave the POS station 100, and likely the venue, without conducting the necessary transaction.

Referring back to FIG. 3, this is achieved by first detecting 302, via vision image-data acquired via the vision imaging assembly 208, movement of a perpetrator (also referred to as a user) through the POS station 100 in the direction of travel 134. It may be important to maintain the detection of movement specifically in one direction of travel as persons moving in the opposite direction are likely not engaged in leaving the venue and are therefore not viewed as being at risk of conducting a shrink event. On the other hand, is it assumed that the direction of travel is the direction that one would take in an effort to leave the venue. Thus, maintaining specific directional travel as a condition to the overall process helps reduce possible instances of false alarms.

Upon detecting movement in the direction of travel, the POS station 100 may then monitor for interaction with the barcode reader 104. As noted previously, under normal circumstances of using POS stations like self-checkouts, users leaving a venue with items will stop in the lane 136 and process their transaction using the barcode 104. Thus, responsive to detecting the movement of the user through the POS station lane 136 in the direction of travel 134 and not processing a decode of a barcode at a barcode reader 104 provides reason to generate an event identifier 304.

The event identifier may take a wide range of forms. In some cases it may be a message sent from the barcode processor 204 to a host 150 indicating that a possible shrink event may have occurred. In some other cases it may be a trigger for the POS station to illuminate a beacon or to sound an auditory signal. In still other cases it may include a message sent to a venue employee, potentially indicating a likely shrink event.

In some embodiments, it is preferable to generate the event identifier if no decode occurs only within a predetermined amount of time. After the detection of motion in the lane 136. This can help provide a user enough time to conduct a transaction so as not to generate a false alarm. Similarly, if the user is detected as passing in the direction opposite of the direction of travel 134, such an event may prevent the generating of the event identifier as it would be assumed that the user is not leaving the venue and that a shrink event is not taking place. This too is preferably considered for a predetermined amount of time and if the user does not return along the reverse path within that time, then an event generator may be generated.

To that extent, in some embodiment and to help prevent false alarms, the POS station may be configured to generate the event identifier responsive to detecting the movement of the user through the POS station in the direction of travel, where the user is in possession of at least one of the item, an item carrier, or a cart. It may be counterproductive to flag every individual passing through the lane 136 as many individuals leave a venue through a lane like line 136 leave simply because they are not interested in purchasing any items. Focusing on individuals that are in possession of items or carriers that can facilitate the removal of items from a venue can help reduce generating unnecessary event identifiers where persons are not suspected of being in possession of an item.

Further, the POS system may be configured to generate the event identifier responsive to detecting the movement of the user through the POS station in the direction of travel and once the user has entered or passed through the egress point. This again provides an opportunity for the user to conduct a transaction operation prior to causing an event identifier to be generated.

Additionally, in some embodiments the POS station is configured to identify which item is being carried, directly or indirectly, through lane 136. Identifying an item can be achieved by analyzing the image data obtained by the vision imaging assembly and can be further used by the venue to identify which items are no longer within the venue. This can be further utilized to help restock items which have been removed without a trackable operation such as a transaction performed with the use of the POS station 100.

The above description refers to a block diagram of the accompanying drawings. Alternative implementations of the example represented by the block diagram includes one or more additional or alternative elements, processes and/or devices. Additionally or alternatively, one or more of the example blocks of the diagram may be combined, divided, re-arranged or omitted. Components represented by the blocks of the diagram are implemented by hardware, software, firmware, and/or any combination of hardware, software and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAs, are specifically configured hardware for performing operations (e.g., one or more of the operations described herein and represented by the flowcharts of this disclosure, if such are present). Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions. The above description refers to various operations described herein and flowcharts that may be appended hereto to illustrate the flow of those operations. Any such flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may combined, divided, re-arranged or omitted. In some examples, the operations described herein are implemented by machine-readable instructions (e.g., software and/or firmware) stored on a medium (e.g., a tangible machine-readable medium) for execution by one or more logic circuits (e.g., processor(s)). In some examples, the operations described herein are implemented by one or more configurations of one or more specifically designed logic circuits (e.g., ASIC(s)). In some examples the operations described herein are implemented by a combination of specifically designed logic circuit(s) and machine-readable instructions stored on a medium (e.g., a tangible machine-readable medium) for execution by logic circuit(s).

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device” can be read to be implemented by a propagating signal.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. A vision system for use at a point-of-sale (POS) station of a venue, the POS station having an ingress region, an egress region, and a direction of travel extending from the ingress region to the egress region, the system comprising:
a stationary barcode scanner having associated therewith a first imaging assembly operable to capture first image-data and a second imaging assembly operable to capture second image-data, the barcode scanner being configured to operate between the ingress region and the egress region;
at least one processor; and
a memory storing computer readable instructions that, when executed by the at least one processor, cause the at least one processor to:
decode, via the first image-data, barcodes associated with items presented to the barcode scanner within a product scanning region of the barcode scanner,
detect, via the second image-data, movement of users through the POS station in the direction of travel, and
generate an event identifier responsive to (i) detecting a movement of a user through the POS station in the direction of travel and (ii) not processing a decode of a barcode associated with an item.

2. The vision system of claim 1, wherein the computer readable instructions, when executed by the at least one processor, further cause the at least one processor to generate the event identifier responsive to (i) detecting the movement of the user through the POS station in the direction of travel and (ii) the not processing the decode of the barcode associated with the item within a predetermined amount of time after detecting the movement of the user through the POS station in the direction of travel.

3. The vision system of claim 1, wherein the computer readable instructions, when executed by the at least one processor, further cause the at least one processor to not generate the event identifier responsive to (iii) detecting a second movement of the user through the POS station opposite of the direction of travel.

4. The vision system of claim 3, wherein the computer readable instructions, when executed by the at least one processor, further cause the at least one processor to not generate the event identifier responsive to (iii) detecting the second movement of the user through the POS station opposite of the direction of travel within a predetermined amount of time from the time that the movement of users through the POS station in the direction of travel was detected.

5. The vision system of claim 1, wherein the first imaging assembly includes a monochromatic imaging sensor, and wherein the second imaging assembly includes a polychromatic imaging sensor.

6. The vision system of claim 5, wherein the first imaging assembly and the second imaging assembly are housed within a housing of the barcode scanner.

7. The vision system of claim 1, wherein the product scanning region is defined by a field of view (FOV) of the first imaging assembly, and wherein a FOV of the second imaging assembly overlaps, at least partially, with the FOV of the first imaging assembly.

8. The vision system of claim 7, wherein an overall width of the FOV of the second imaging assembly, as measured at a maximum working distance of second imaging assembly, is greater than an overall width of the FOV of the first imaging assembly, as measured at a maximum working distance of first imaging assembly.

9. The vision system of claim 1, wherein the computer readable instructions, when executed by the at least one processor, further cause the at least one processor to generate the event identifier responsive to (i) detecting the movement of the user through the POS station in the direction of travel, where the user is in possession of at least one of the item, an item carrier, or a cart.

10. The vision system of claim 1, wherein the computer readable instructions, when executed by the at least one processor, further cause the at least one processor to not generate the event identifier responsive to (i) detecting the movement of the user through the POS station in the direction of travel, and (iii) processing the decode of the barcode associated with the item.

11. The vision system of claim 1, wherein the at least one processor is housed within a housing of the barcode scanner.

12. A method for imaging-based vision analysis at a point-of-sale (POS) station of a venue, the POS station having an ingress region, an egress region, and a direction of travel extending from the ingress region to the egress region, the method comprising:
detecting, via vision image-data acquired via a vision imaging assembly, movement of a user through the POS station in the direction of travel; and
generating an event identifier responsive to (i) the detecting the movement of the user through the POS station in the direction of travel and (ii) not processing a decode of a barcode associated with an item, wherein the decode of the barcode would be performed by image analysis of barcode image-data acquired via a barcode imaging assembly having a field of view (FOV) extending over a product scanning region of a stationary barcode scanner.

13. The method of claim 12, wherein generating the event identifier is further responsive to not processing the decode of the barcode within a predetermined amount of time after the detecting the movement of the user through the POS station in the direction of travel.

14. The method of claim 12, wherein the barcode imaging assembly includes a monochromatic imaging sensor, and wherein the vision imaging assembly includes a polychromatic imaging sensor.

15. The method of claim 14, wherein the barcode imaging assembly and the vision imaging assembly are housed within a housing of the barcode scanner.

16. The method of claim 12, wherein the product scanning region is defined by the FOV of the barcode imaging assembly, and wherein a FOV of the vision imaging assembly overlaps, at least partially, with the FOV of the barcode imaging assembly.

17. The method of claim 16, wherein an overall width of the FOV of the vision imaging assembly, as measured at a maximum working distance of vision imaging assembly, is greater than an overall width of the FOV of the barcode imaging assembly, as measured at a maximum working distance of barcode imaging assembly.

18. The method of claim 12, wherein the generating the event identifier is further responsive to detecting the movement of the user through the POS station in the direction of travel, where the user is in possession of at least one of the item, an item carrier, or a cart.

19. The method of claim 12, further comprising not generating the event identifier responsive to (i) the detecting the movement of the user through the POS station in the direction of travel, and (iii) processing the decode of the barcode associated with the item.

20. The method of claim 12, wherein the detecting the movement and the generating the event identifier is performed via at least one processor that is housed within a housing of the barcode scanner.
